(19) United States
(12) Patent Application Publication
(10) Pub. No.: US 2008/0250507 A1
(43) Pub. Date: Oct. 9, 2008

(54) Information Sharing System, Information Processing Device, and Control Program

(75) Inventor: Kazuhiro Yoshida, Chonburi (TH)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/574,432

(22) PCT Filed: Aug. 29, 2005
(86) PCT No.: PCT/JP05/16167

§ 371 Date: Sep. 21, 2007

(30) Foreign Application Priority Data
Aug. 30, 2004 (JP) 2004-250556

(51) Int. Cl. H04L 9/32; G06F 15/16

(52) U.S. Cl. 726/28; 709/204; 709/206

(57) ABSTRACT

In an information sharing system including an information reading device and an information processing device, the information reading device includes: a member information reading unit for reading member information from member discrimination cards respectively owned by a plurality of members; and a transmitting unit for transmitting the member information read by the member information reading unit to the information processing device. The information processing device includes: a receiving unit for receiving the member information transmitted from the transmitting unit; an address information detection unit for detecting address information corresponding to the received member information; and an information sharing member list forming unit for forming an information sharing member list based on the address information detected by the address information detection unit.

### TECHNICAL FIELD

The present invention relates to an information sharing system, an information processing device, and a control program. In particular, the present invention relates to an information sharing system for forming an information sharing member list using a member discrimination card owned by each member, an information processing device, and a control program.

### BACKGROUND ART

There is a case where participants of a conference share a material used in the conference, conference minutes, and the like. According to. Japanese Patent Application Laid-Open No. 2003-244241, an organizer of a conference forms a mailing list, and participants of the conference send a material to be shared and the like to the mailing list.

It is also considered that the participants and the organizer of the conference upload the material to be shaped to a server prepared by the organizer, and obtain passwords and the like for accessing the material to be shaped in the server. This enables the participants and the organizer of the conference to freely access the material to be shaped.

On the other hand, in order to prevent a third party from accessing the material to be shared and the like accumulated in the server, Japanese Patent Application Laid-Open No. H05-094389 describes measures of applying an access limit to the material to be shared, shared folders, and the like accumulated in the server.

However, the above-mentioned mailing list is formed manually by the conference organizer. Therefore, there is a fear in that registration oversight, errors in writing, and the like of mail addresses may occur in the mailing list. Furthermore, the organizer takes labor and time for forming the mailing list.

On the other hand, according to the method of applying an access limit to the material to be shared, shared folders, and the like accumulated in the server, the operation of applying an access limit is performed manually, which may cause registration oversight of an access-permitted member. Furthermore, an administrator of the server (e.g., a conference organizer) takes labor and time for applying an access limit.

### DISCLOSURE OF THE INVENTION

An object of the present invention is to provide an information sharing system, an information processing device, and a control program with which automatic formation of a mailing list or automatic giving of an access right to a shared folder can be made.

To achieve the above-mentioned object, according to a first aspect of the present invention, there is provided an information sharing system including an information reading device and an information processing device, in which the information reading device includes: a member information reading unit for reading member information from member discrimination cards respectively owned by a plurality of members; and a transmitting unit for transmitting the member information read by the member information reading unit to the information processing device, and the information processing device includes: a receiving unit for receiving the member information transmitted from the transmitting unit; an address information detection unit for detecting address information corresponding to the received member information; and an information sharing member list forming unit for forming an information sharing member list based on the address information detected by the address information detection unit.

To achieve the above-mentioned object, according to a second aspect of the present invention, there is provided an information sharing system including an information reading device and an information processing device, in which the information reading device includes: a member information reading unit for reading member information from member discrimination cards respectively owned by a plurality of members; and a transmitting unit for transmitting the member information read by the member information reading unit to the information processing device, the information processing device includes: a receiving unit for receiving the member information transmitted from the transmitting unit; a storage unit for storing information to be shared by the plurality of members; a detection unit for detecting member discrimination information corresponding to the received member information; and a registration unit for registering the member discrimination information detected by the detection unit as member discrimination information that permits an access to the storage unit.

To achieve the above-mentioned object, according to a third aspect of the present invention, there is provided an information sharing system including an information reading device, and an information processing device, in which the information reading device includes: a member information reading unit for reading member information from member discrimination cards respectively owned by a plurality of members; and a transmitting unit for transmitting the member information read by the member information reading unit to the information processing device, the information processing device includes: a receiving unit for receiving the member information transmitted from the transmitting unit; a detection unit for detecting member discrimination information corresponding to the received member information; and an instruction outputting unit for outputting an instruction of registering the member discrimination information detected by the detection unit as member discrimination information that permits an access to the information storage device, to the information storage device, and the information storage device includes a registration unit for registering the member discrimination information detected by the detection unit as member discrimination information that permits an access to the information storage device, based on the instruction from the instruction output unit.

Other features and advantages of the present invention will be apparent from the following description when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing a configuration of an information sharing system according to an embodiment of the present invention.

FIG. 2 is a block diagram showing a hardware configuration of a main server 109.

FIG. 3 is a diagram showing a configuration of data included in an RFID tag portion 108 in FIG. 1.

FIG. 4 is a block diagram showing a configuration of an RFID reader/writer unit 107 in FIG. 1.

FIG. 5 is a block diagram showing a configuration of the RFID tag portion 108 in FIG. 1.

FIG. 6 is a flow chart showing information communication processing executed between the RFID tag portion 108 in the case of entering an area 101 and the RFID reader/writer unit 107 set at an entrance of the area 101.

FIG. 7 is a flowchart illustrating processing in which a mail server 104 forms a mailing list.

FIG. 8 is a flowchart illustrating processing in which a file server 103 adds an access right to a shared folder of the file server 103.

### BEST MODE FOR CARRYING OUT THE INVENTION

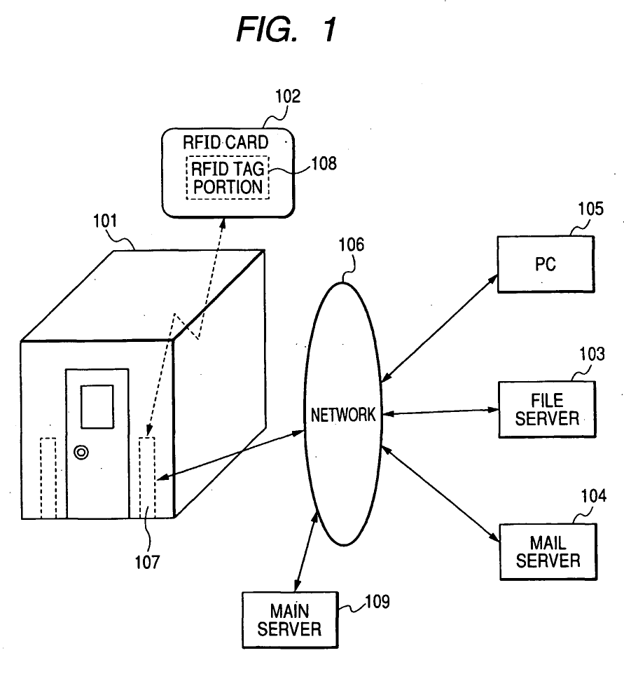

Hereinafter, an embodiment of the present invention will be described with reference to FIGS. 1 to 6.

FIG. 1 shows a configuration of an information sharing system according to an embodiment of the present invention.

The system is composed of an area 101 such as a conference room in which a Radio Frequency-Identification (RFID) reader mechanism is set at an entrance, an RFID card 102 owned by each member, a file server 103 storing document data and the like, a mail server 104 managing the transmission/reception of mail and a mailing list, and a main server 109 controlling the entire system.

In the FID card 102, an RFID tag portion 108 is embedded.

In the figure, reference numeral 106 denotes a network such as a local area network (LAN) or the like, and is connected to a PC 105, the file server 103, the mail server 104., and the main server 109.

At the entrance of the area 101, an RFID reader/writer unit 107 capable of reading and writing information stored in the RFID tag portion 108 is provided. The RFID reader/writer unit 107 can read and write information in a non-contact state without allowing the RFID tag portion 108 to come into contact therewith.

The RFID reader/writer unit 107 is connected to the network 106, and transmits information read from the RFID tag portion 108 to the file server 103 or the main server 109 via the network 106.

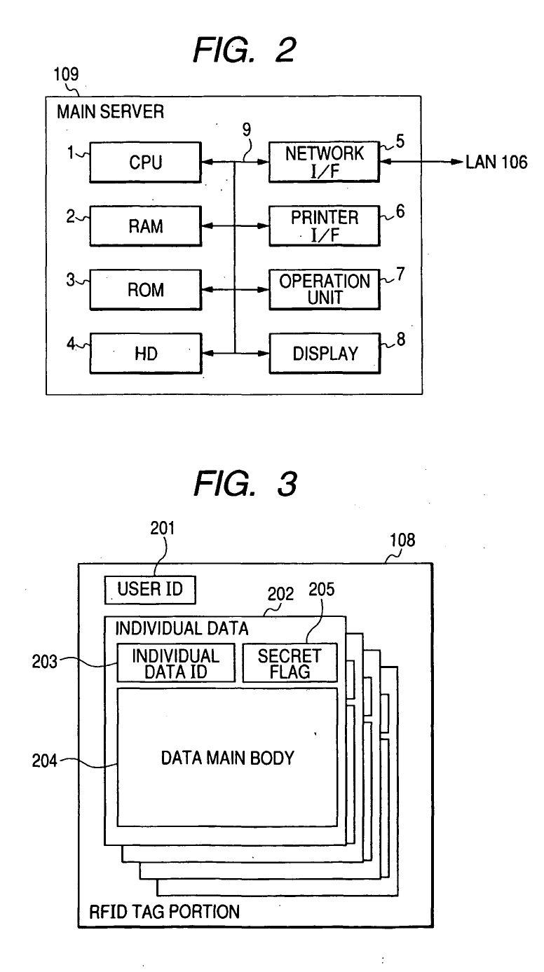

FIG. 2 is a block diagram showing a hardware configuration of the main server 109;

The main server 109 includes a CPU 1, a RAM 2, a ROM 3, an HD (hard disk) 4, a network I/F 5, a printer I/F 6, an operation unit 7 such as a keyboard and a mouse, and a display 8. These components are all connected to a bus 9. Furthermore, the network I/F 5 is connected to the LAN 106 in FIG. 1. A hard disk 4 stores data representing a correspondence relationship between a user ID 201 (described later) and a mail address or an account as table data. FIG. 2 shows a hardware configuration of the main server 109. The file server 103, the mail server 104, and the PC 105 shown in FIG. 1 also have a similar hardware configuration. The hard disk of the file server 103 has a shared folder as described later.

FIG. 3 shows a configuration of data included in the RFID tag portion 108 shown in FIG. 1.

The exchange of information between the RFID card 102 and the RFID reader/writer unit 107 in this system will be described.

In the RFID tag portion 108, a specific user ID 201 and individual data 202 are stored for each user. The user ID 201 and the individual data 202 constitute member information.

In the RFID tag portion 108, a specific numerical value is assigned as the user ID 201. The main server 109 can recognize an individual owning the RFID card 102 based on the user ID 201. Although the number of individual data 202 to be stored varies depending upon the user, one or a plurality of individual data 202 are stored: in one RFID tag portion 108. The individual data 202 includes individual data ID 203, a data main body 204, and a secret flag 205.

A mail address and an account can be stored in the individual data 202. When a plurality of individual data 202 are stored in the RFID tag portion 108, a mail address or an account common to all the individual data 202 is stored. More specifically, a mail address or an account varying depending upon the individual data 202 cannot be stored. Furthermore, when a plurality of individual data 202 are stored in the RFID tag portion 108, when a mail address or an account is stored in one individual data 202, the stored mail address or account is reflected on all the plurality of individual data 202. This also applies to the case where a mail address or an account is rewritten.

The individual data ID 203 is assigned an arbitrary numerical value for each individual data, and the individual data ID 203 is combined with the user ID 201, whereby the exchange of various kinds of data can be started with respect to the file server 103 or the main server 109 via the RFID reader/writer unit 107.

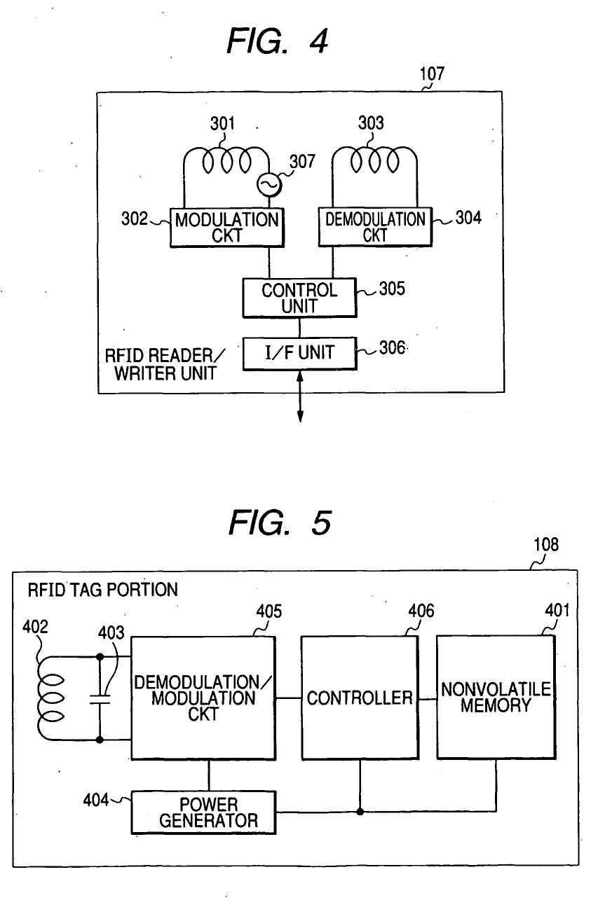

The secret flag 205 determines the acceptance/rejection of reading of the data main body 204 by the RFID reader/writer unit 107. In order to prevent secret data from being disclosed to a third party by mistake, the data main body 204 with the secret flag 205 attached thereto cannot be read by the RFID reader/writer unit 107 in principle. However, by setting a control unit 305 (FIG. 4) (described later) in the RFID reader/writer unit 107, the data main body 204 with the secret flag 205 attached thereto can also be read. Furthermore, the data main body 204 read herein can be transmitted to a mailing list or a shared folder described later. Furthermore, the data main body 204 with the secret flag 205 attached thereto may be read by a particular terminal or a particular authentication method.

FIG. 4 is a block diagram showing a schematic configuration of the RFID reader/writer unit 107 shown in FIG. 1.

The RFID reader/writer unit 107 includes a transmitting antenna unit 301, a modulation circuit 302, a receiving antenna unit 303, a demodulation circuit 304, a control unit 305, an I/F unit (transmitting means) 306, and a power source 307. The transmitting antenna unit 301 transmits a radio wave to the RFID tag portion 108. The modulation circuit 302 modulates a radio wave transmitted from the transmitting antenna unit 301. The receiving antenna unit 303 receives a radio wave transmitted from the RFID tag portion 108. The demodulation circuit 304 demodulates a signal received from the receiving antenna unit 303. The control unit 305 controls the transmitting antenna unit 301, the modulation circuit 302, the receiving antenna unit 303, and the demodulation circuit 304. The I/F unit 306 communicates with the main server 109 via the network 106. The power source 307 is connected to the transmitting antenna unit 301, and supplies a power to the RFID tag portion 108.

The control unit 305 modulates a radio wave for supplying a power to the RFID tag portion 108 and data to be transmitted, using the modulation circuit 302 in accordance with an instruction from outside, and transmits a radio wave to outside from the transmitting antenna unit 301. Furthermore, the control unit 305 can receive a radio signal received from outside at the receiving antenna unit 303, demodulate it with the demodulation circuit 304, and convert it so that the demodulated signal can be handled as a data signal.

FIG. 5 is a block diagram showing a configuration of the RFID tag portion 108 shown in FIG. 1.

The RFID tag portion 108 includes a nonvolatile memory 401, an antenna unit 402 for transmitting/receiving a radio wave, a resonant capacitor unit 403, a power generator 404 for rectifying/smoothing a power source, a demodulation/modulation circuit 405 for modulating and demodulating a radio wave, and a controller 406.

The antenna unit 402 is combined with the resonant capacitor 403 to constitute a resonant circuit. Upon receiving a radio signal transmitted from the RFID reader/writer unit 107, the resonant circuit supplies the radio signal to the power generator 404. Because of this., the power generator 404 becomes able to obtain a power for operating the RFID tag portion 108. The power generator 404 supplies the obtained power to the nonvolatile memory 401 and the demodulation/modulation circuit 405.

The controller 406 controls the demodulation/modulation circuit 405 and the power generator 404 in accordance with a program stored in the nonvolatile memory 401. More specifically, the controller 406 controls the RFID tag portion 108.

The antenna unit 402 transmits/receives data to be read or written in the RFID tag portion 108 in synchronization with a radio signal transmitted from the RFID reader/writer unit 107. The signal transmitted to the RFID tag portion 108 is demodulated with the demodulation/modulation circuit 405, and stored in the nonvolatile memory 401 via the controller 406. Furthermore, the data read from the nonvolatile memory 401 by the controller 406 is modulated as a signal by the demodulation/modulation circuit 405. The modulated signal can be transmitted from the antenna unit 402 to the RFID reader/writer unit 107 as a radio signal.

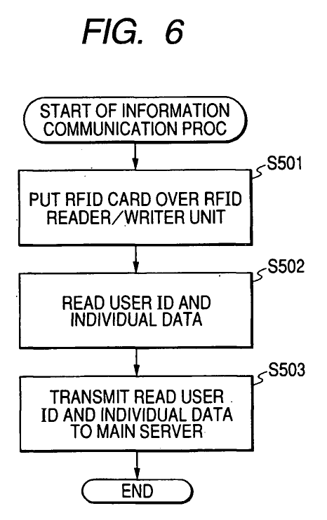

FIG. 6 is a flowchart illustrating information communication processing executed between the RFID tag portion 108 and the RFID reader/writer unit 107 set at the entrance of the area 101 in the case of entering the area 101.

First, in order to enter the area 101, a conference member holds the RFID card 102 over the RFID reader/writer unit 107 set at the entrance when passing through the entrance of the area 101 (step S501). Then, the transmitting antenna unit 307 in the RFID reader/writer unit 107 transmits a radio signal for supplying a power to the RFID tag portion 108. Because of this, the RFID reader/writer unit 107 supplies a power to the RFID tag portion 108, and the user ID 201 and the individual data 202 in the RFID card 102 are read by the RFID reader/writer unit 107 (step S502). The RFID reader/writer unit 107 transmits the read user ID 201 and individual data 202 to the main server 109 via the network 106 (step S503), and the processing is completed.

As a modified example of the processing, a gate may be provided at the entrance of the area 101 so that a radio signal for supplying a power is output from the gate to the RFID tag portion 108. Because of this, the conference member does not need to hold the RFID card 102 over the RFID reader/writer unit 107. That is, only by allowing a conference member to pass through the gate, the user ID 201 and the individual data 202 in the RFID card 102 are read. Thus, for example, the crowdedness with conference members at the entrance of the area is eliminated. Furthermore, a conference member owning the RFID card 102 can contribute to the formation of a mailing list and the giving of an access right to a shared folder, described later, without being aware of it. In this case, it is preferable that a conference member be considered as having participated in a conference when the conference member stays in the conference room for a predetermined period of time or longer after passing through the gate to enter the conference room. The reason for this is to prevent a person who enters the conference room temporarily to give a message to a participant in the conference from being considered as a conference member.

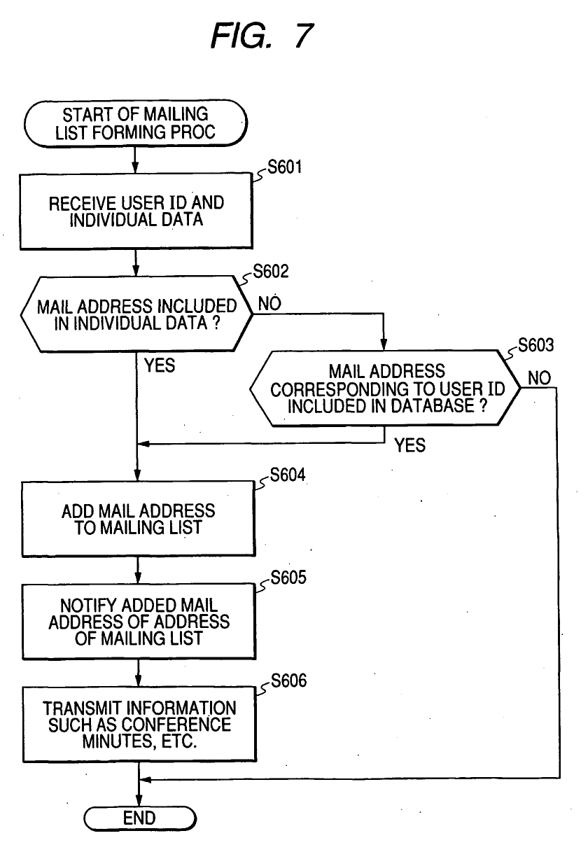

FIG. 7 is a flowchart illustrating the processing in which the main server 109 forms a mailing list based on the information transmitted from the RFID reader/writer portion 107. The processing is mainly executed by the CPU 1 of the main server 109.

First, the main server 109 receives the user ID 201 and the individual data 202 transmitted from the RFID reader/writer unit 107 (step S601).

Then, it is determined whether or not a mail address is included in the individual data 202 received in step S601 (step S602).

In step S602, when it is determined that a mail address is included, the main server 109 adds the mail address to a mailing list (information sharing member list) (step S604).

In step S602, when it is determined that a mail address is not included, it is determined whether or not a mail address corresponding to the user ID 201 is included in a database recorded in the hard disk 4 of the main server 109 (step S603).

In step S603, when it is determined that a mail address corresponding to the user ID 201 is included, the process proceeds to the above-mentioned step S604. On the other hand, when it is determined that a mail address corresponding to the user ID 201 is not included, the processing is completed.

Then, in the processing in step S604, in accordance with a predetermined operation, or after recognizing that all the members left, using the RFID reader/writer unit 107, it is determined that the processing is completed, and the process proceeds to the processing in step S605. Herein, the predetermined operation refers to, for example, an operation of a switch for designating the completion of a conference set in a conference room or an operation for completing the conference in the main server 109.

After the processing in step S604, the main server 109 generates a mail address (address of a mailing list) at which mail reaches all the members added to a mailing list. The main server 109 uses this mail address (address of a mailing list) to notify the members added to the mailing list of this mail address (address of a mailing list) (step S605). If mail is transmitted to the mail address (address of a mailing list) generated herein as a destination, the main server 109 once receives the mail. The main server 109 then transmits the same mail to each mail address of the members included in the mailing list with the mail address of the mailing list being described in a destination filed. If the address of the mailing list is described in the destination field, the address of the mailing list is shown in a region showing a recipient address of mail software of a recipient. That is, the recipient of the mail can know the address of the mailing list. In step S605, the main server 109 may transmit so-called empty mail without a main body to the mail address added to the mailing list. Alternatively, the main server 109 may transmit a fixed sentence describing the address of the mailing list as a mail main body. It is preferable that a conference ID specifying the conference be generated and included in the address of the mailing list generated at this time. Even if the conference ID is not included in the address, the conference ID may be inserted in a Subject or a main body. Furthermore, instead of separately generating an address for a mailing list, an actual mail address of each member may be inserted in a destination address as it is to be transmitted. However, in this case, there is a possibility that there is a member desiring to make his/her mail address secret, so that it is preferable to generate a mailing list separately. It is preferable that the conference ID is in the form of an appropriate combination of a conference room name, a conference date and time, and the like.

After this, the main server 109 transmits information such as the minutes of the conference to the mail addresses included in the mailing list via the mail server 103 (step S606), and the processing is completed. The notifying means at this time is mail. Regarding the processing in step S606, a script requiring that data (e.g., information such as the minutes of the conference) stored in a predetermined region of the hard disk 4 be transmitted to the mailing list formed in step S604 by mail is previously generated, and the main server 109 may execute the script. In such a case, the organizer of the conference registers the information such as the minutes of the conference in the above-mentioned predetermined region of the hard disk 4 after specifying the conference ID generated in the above, whereby the organizer can transmit the information such as the minutes of the conference to the mail addresses included in the mailing list automatically.

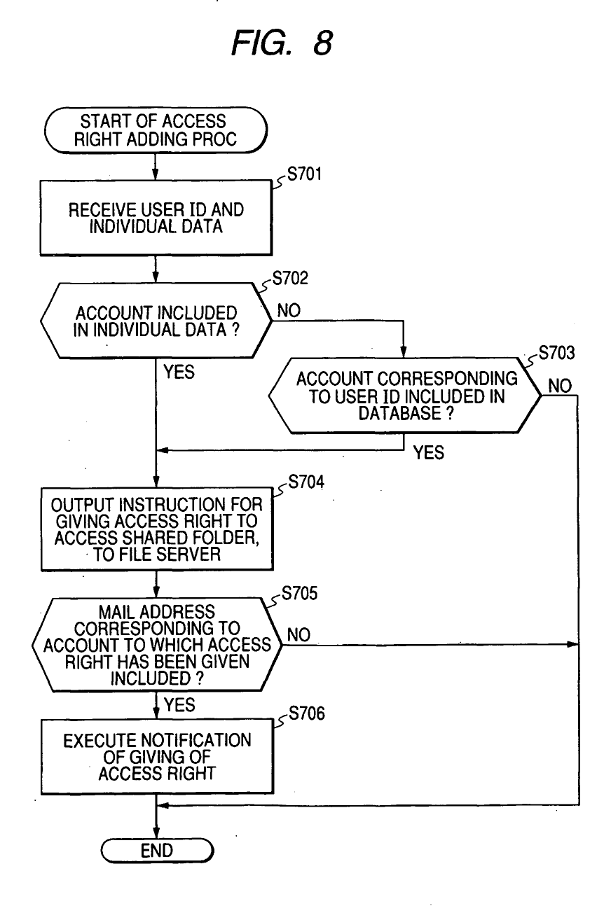

FIG. 8 is a flowchart illustrating the processing in which the main server 109 adds an access right to a shared folder of the file server 103, based on the information transmitted from the RFID reader/writer unit 107. This processing is mainly executed by the CPU 1 of the main server 109.

Regarding the shared folder, a conference ID may be associated with a folder that is previously present, or a shared folder may be formed newly based on the conference ID. In the case of newly forming a shared folder, it is convenient to set a folder name including the conference ID, because it is easy to know which conference the shared folder belongs to.

First, the main server 109 receives the user ID 201 and the individual data 202 transmitted from the RFID reader/writer unit 107 (step S701).

Next, the main server 109 determines whether or not an account is included in the individual data 202 received in step S701 (step S702).

In step S702, when it is determined that an account is included in the individual data 202, the process proceeds to step S704. In step S704, the mail server 109 outputs to the file server 103 an instruction of giving an access right to the above-mentioned predetermined shared folder included in the hard disk of the mail server 103 to the account included in the individual data 202. Because of this, the CPU of the file server 103 gives an access right to the shared folder to the account included in the individual data 202. The organizer or the like of the conference previously stores the information such as the minutes of the conference in the predetermined shared folder included in the hard disk of the file server 103.

In step S702, when it is determined that an account is not included in the individual data 202, the process proceeds to step S703. In step S703, the main server 109 determines whether or not an account corresponding to the user ID 201 in the database recorded in the file server 103 is included.

In step S703, when it is determined that an account corresponding to the user ID 201 in the database is included, the process proceeds to the above-mentioned step S704. On the other hand, when an account corresponding to the user ID 201 in the database is not included, the processing is completed.

In step S705, the main server 109 determines whether or not a mail address corresponding to an account with an access right given thereto is included in the received user ID 201 and individual data 202 in step S701. When a mail address is not included, the processing is completed. On the other hand, when a mail address is included, mail for notifying that an access right has been given to the mail address is transmitted (step S706), and the processing is completed.

Regarding the processing of setting an access right, in the same way as in the above-mentioned processing of forming a mailing list, the completion of the processing is determined by a predetermined operation or by recognizing that all the members left with the RFID reader/writer 107.

In order to store the minutes and the like in the shared folder, the organizer of the conference performs an operation of directly storing the minutes and the like in the shared folder of the file server 103. Furthermore, when a conference ID is specified and the minutes are transmitted to the main server 109, the main server 109 may automatically store the minutes in the shared folder associated with the conference ID of the file server 103. When the minutes are stored in the shared folder, mail notifying this may be transmitted automatically to all the members. In this case, the mail is transmitted to the mail address recognized in step S707, and in addition, the procedure as shown in FIG. 7 may be used. That is, the processing in FIG. 7 and the processing in FIG. 8 may be combined appropriately in an organic manner. Needless to say, this enables further functional effects to be expected.

As described above in detail, according to this embodiment, the RFID reader/writer unit 107 reads the user ID 201 and the individual data 202 in the RFID card 102 and sends them to the main server 109. Then, the main server 109 receives the user ID 201 and the individual data, 202 transmitted from the RFID reader/writer unit 107. When a mail address is included in the database recorded in the received individual data 202 or hard disk 4, the main server 109 adds the mail address to a mailing list. Because of this, the formation of a mailing list of members having participated in the conference can be automated. Then, the information such as the minutes of the conference can be provided efficiently to the members having participated in the conference, and the information can be shared among the members.

Furthermore, the RFID reader/writer unit 107 reads the user ID 201 and the individual data 202 in the RFID card 102, and transmits them to the main server 109. Then, the main server 109 receives the user ID 201 and the individual data 202 transmitted from the RFID reader/writer unit 107. When an account is included in the database recorded in the received individual data 202 or file server 103, the main server 109 outputs to the file server 103 an instruction of giving an access right to a predetermined shared folder included in the hard disk of the file server 103 to the account. Because of this, the giving of an access right to the shared folder for the members having participated in the conference can be automated. Then, the information such as the minutes of the conference can be provided efficiently to the members having participated in the conference, and the information can be shared among the members.

In the above-mentioned embodiment, three servers, namely the file server 103, the mail server 104, and the main server 109 are present. However, by allowing the main server 109 to have functions of the file server 103 and the mail server 104, the respective processing executed by the three servers may be executed only with the main server 109. In such a case., the main server 109 receives the user ID 201 and the individual data 202 transmitted from the RFID reader/writer unit 107. When an account is included in the database recorded in the received individual data 202 or hard disk 4, the main server 109 gives an access right to a predetermined shared folder included in the hard disk 4 to the account. Because of this, the giving of an access right to the shared folder for the members having participated in the conference can be automated. Then, the information such as the minutes of the conference can be provided efficiently to the members having participated in the conference, and the information can be shared among the members.

In the above embodiment, although the case where the user ID 201 and the individual data 202 are both included in the RFID tag portion 108 is assumed, only the user ID 201 may be included in the RFID tag portion 108. In this case, data representing the correspondence relationship between the user ID 201 and the individual data 202, and data representing the correspondence relationship between the individual data 202 and the mail address or account is stored as table data in the hard disk 4 of the main server 109. This enables the storage capacity of the RFID tag portion 108 to be reduced.

Furthermore, in the above embodiment, a conference member or a conference organizer may access a mailing list formed by the main server 109, and add or delete a mail address.

Furthermore, in the above embodiment, although a member is recognized using the RFID card, various cards capable of recognizing a member such as a contact-type IC card may be used instead.

The present invention may be achieved as follows. A storage medium storing a program cord of software realizing the function of the above embodiment is supplied to a system or an apparatus. Then, a computer (or a CPU or an MPU) of the system or the apparatus may read the program cord stored in the storage medium to execute it.

In this case, the program cord itself read from the storage medium realizes the function of the above-mentioned embodiment, whereby the program cord and the storage medium storing the program cord constitute the present invention.

Furthermore, it is appreciated that, by executing the program cord read by the computer, the function of the above-mentioned embodiment is realized, and in addition, based on the instruction of the program cord, an operating system (OS) working on the computer performs a part or an entirety of actual processing, and the function of the above-mentioned embodiment is realized by the processing.

Furthermore, the program cord read from the storage medium is written in a memory provided in a function extension card inserted in the computer or a function extension unit connected to the computer. Then, based on the instruction of the program cord, a CPU or the like provided in the function extension card and the function extension unit performs a part or an entirety of the actual processing. It is appreciated that the case where the function of the above-mentioned embodiment is realized by the processing is also included in the present invention.

Furthermore, the above-mentioned program only needs to realize the function of the above-mentioned embodiment with a computer, and its form may be a program executed by an object cord or an interpreter, script data supplied to the OS, or the like.

Examples of the recording medium supplying a program include a floppy (Registered Trade Mark) disk, a hard disk, an optical disk, a magnetooptical disk, a CD-ROM, an MO, a CD-R, a CD-RW, a DVD (DVD-ROM, DVD-RAM, DVD-RW, DVD+RW), a magnetic tape, a nonvolatile memory card, and other ROMs. Alternatively, the above-mentioned program is supplied by being downloaded from a computer, a database, or the like (not shown) connected to the Internet, a commercial network, a local area network, or the like.

This application claims priority from Japanese Patent Application No. 2004-250556 filed on Aug. 30, 2004, which is hereby incorporated by reference herein.

1. An information sharing system, comprising an information reading device and an information processing device,
wherein the information reading device comprises:
a member information reading unit for reading member information from member discrimination cards respectively owned by a plurality of members; and
a transmitting unit for transmitting the member information read by the member information reading unit to the information processing device, and
the information processing device comprises:
a receiving unit for receiving the member information transmitted from the transmitting unit;
an address information detection unit for detecting address information corresponding to the received member information; and
an information sharing member list forming unit for forming an information sharing member list based on the address information detected by the address information detection unit.

2. An information sharing system according to claim 1,
wherein the information processing device further comprises a shared information transmitting unit for transmitting information shared among the plurality of members to the address information registered in the information sharing member list formed by the information sharing member list forming unit.

3. An information sharing system according to claim 1, wherein the information processing device further comprises a storage unit for storing a database in which the member information is associated with the address information, and
the address information detection unit detects the address information corresponding to the received member information from the database when the address information cannot be detected from the received member information.

4. An information sharing system according to claim 1, wherein the member discrimination card is an RFID card.

5. An information sharing system, comprising an information reading device and an information processing device,
wherein the information reading device comprises:
a member information reading unit for reading member information from member discrimination cards respectively owned by a plurality of members; and
a transmitting unit for transmitting the member information read by the member information reading unit to the information processing device, and
the information processing device comprises:
a receiving unit for receiving the member information transmitted from the transmitting unit;
a storage unit for storing information to be shared by the plurality of members;
a detection unit for detecting member discrimination information corresponding to the received member information; and
a registration unit for registering the member discrimination information detected by the detection unit as member discrimination information that permits an access to the storage unit.

6. An information sharing system, comprising an information storage device, an information reading device, and an information processing device,
wherein the information reading device comprises:
a member information reading unit for reading member information from member discrimination cards respectively owned by a plurality of members; and
a transmitting unit for transmitting the member information read by the member information reading unit to the information processing device,
the information processing device comprises:
a receiving unit for receiving the member information transmitted from the transmitting unit;
a detection unit for detecting member discrimination information corresponding to the received member information; and
an instruction outputting unit for outputting an instruction of registering the member discrimination information detected by the detection unit as member discrimination information that permits an access to the information storage device, to the information storage device, and
the information storage device comprises a registration unit for registering the member discrimination information detected by the detection unit as member discrimination information that permits an access to the information storage device, based on the instruction from the instruction output unit.

7. An information sharing system according to claim 5, wherein the information processing device further comprises:
a determination unit for determining whether or not address information corresponding to the member discrimination information registered by the registration unit is included in the member information; and
a notifying unit for notifying the address information that the member discrimination information is registered by the registration unit, when it is determined that the address information is included in the member information by the discrimination unit.

8. An information sharing system according to claim 5, wherein the information processing device further comprises a storage unit for storing a database in which the member information is associated with the member discrimination information, and the detecting unit detects the member discrimination information corresponding to the received member information from the database when the member discrimination information cannot be detected from the received member information.

9. An information sharing system according to claim 5, wherein the member discrimination card is an RFID card.

10. An information processing device connected to an information reading device for reading member information from member discrimination cards respectively owned by a plurality of members, comprising:
a receiving unit for receiving the member information read by the information reading device;
an address information detecting unit for detecting address information corresponding to the received member information; and
an information sharing member list forming unit for forming an information sharing member list based on the address information detected by the address information detecting unit.

11. An information processing device connected to an information reading device for reading member information from member discrimination cards respectively owned by a plurality of members, comprising:
a receiving unit for receiving the member information read by the information reading device;
a storage unit for storing information to be shared by the plurality of members;
a detecting unit for detecting member discrimination information corresponding to the received member information; and
a registration unit for registering the member discrimination information detected by the detecting unit as member discrimination information that permits an access to the storage unit.

12. An information processing device connected to an information storage device for storing information to be shared by a plurality of members and an information reading device for reading member information from member discrimination cards respectively owned by the plurality of members, comprising:
a receiving unit for receiving the member information read by the information reading device;
a detecting unit for detecting member discrimination information corresponding to the received member information; and
an instruction outputting unit for outputting an instruction of registering the member discrimination information detected by the detection unit as member discrimination information that permits an access to the information storage device, to the information storage device.

13. A control program executed by a computer connected to an information reading device for reading member information from member discrimination cards respectively owned by a plurality of members, comprising:
a receiving module for receiving the member information read by the information reading device;
an address information detecting module for detecting address information corresponding to the received member information; and
an information sharing member list forming module for forming an information sharing member list based on the address information detected by the address information detecting module.

14. A control program executed by a computer having a storage unit connected to an information reading device for reading member information from member discrimination cards respectively owned by a plurality of members, for storing information to be shared by the plurality of members, comprising:
a receiving module for receiving the member information read by the information reading device;
a detecting module for detecting member discrimination information corresponding to the received member information; and
a registration module for registering the member discrimination information detected by the detection module as member discrimination information that permits an access to the storage unit.

15. A control program executed by a computer connected to an information storage device for storing information to be shared by a plurality of members, and an information reading device for reading member information from member discrimination cards respectively owned by the plurality of members, comprising:
a receiving module for receiving member information read by the information reading device;
a detecting module for detecting member discrimination information corresponding to the received member information; and
an instruction output module for outputting an instruction of registering the member discrimination information detected by the detection module as member discrimination information that permits an access to the information storage device, to the information storage device.
